(19) United States
(12) Patent Application Publication
(10) Pub. No.: US 2025/0389080 A1
(43) Pub. Date: Dec. 25, 2025

(54) A METHOD FOR MELT PROCESSING OF TEXTILE WASTE MATERIAL AND PRODUCTS OBTAINED BY THE METHOD

(71) Applicant: CelluCircle AB, Täby (SE)

(72) Inventors: Aji Pallikunnel MATHEW, Täby (SE); Varvara APOSTOLOPOULOU KALKAVOURA, Täby (SE); Maria-Ximena RUIZ-CALDAS, Stockholm (SE); Natalia FIJOL, Solna (SE)

(21) Appl. No.: 18/879,702

(22) PCT Filed: Jun. 22, 2023
(86) PCT No.: PCT/SE2023/050654

§ 371 Date: Dec. 27, 2024

(30) Foreign Application Priority Data
Jun. 30, 2022 (SE) 2250826-1

(51) Int. Cl. D06M 13/52; B29C 48/05; B29C 48/40; B29C 64/118; B29K 1/00; B29K 67/00; B29L 31/50; D06M 13/192

(52) U.S. Cl. CPC D06M 13/52; B29C 48/05; B29C 48/40; B29C 64/118; D06M 13/192; B29K 2001/00; B29K 2067/003; B29L 2031/50

(57) ABSTRACT

A method for melt processing of textile waste material, wherein the textile waste material includes (1) at least one thermoplastic polymer material, such as polyurethane, polyester, nylon, cellulose or elastane, and (2) at least one cellulose-containing material, such as cotton textile, cotton blends with synthetic or natural polymers, regenerated cellulose-based textiles, the method adapted to prepare a composite material, including (a) chemical pretreatment of the textile waste material; (b) thermomechanical processing of the chemically pretreated material of step (a), including melt compounding, optionally including addition of recycled PET, plasticizers, such as glycerol, PEG and vegetable oils, and/or toughening polymers, such as natural rubber and polyurethane; thereby obtaining a composite material including homogenous polymer composites and/or nanocomposites, wherein the at least one thermoplastic polymer material essentially constitutes a matrix phase and the at least one cellulose-containing material essentially constitutes a reinforcement phase of the composite material.

### TECHNICAL FIELD

The present disclosure relates to a method for melt processing of textile waste material, a composite material obtained by the method, a recycled product obtained by the method, a 3D printable filament obtained by the method and a 3D printed recycled product obtained by the method as defined in the introductory parts of the independent claims.

### BACKGROUND ART

For environmental purposes, there has been a growing demand for means and methods for recycling of waste material. This has also become relevant for textile waste material, in order to produce new products from waste material in an efficient and environmentally friendly way. Today, some methods for recycling and/or separation of the various components of textile waste material are being used. However, current methods have limitations and drawbacks, e.g., for being useful for textile waste material comprising both thermoplastic polymers and cotton and/or cellulose fabrics.

CN-A-113005536 discloses nanoscale plastic particles and a preparation method thereof, involving dissolving plastic powder in an organic solvent. US-A-2019136455 discloses cellulose materials and methods of making the cellulose materials in the context of cotton recycling, wherein the methods involve dissolving or suspending an active ingredient in a medium comprising the cellulose material by contacting a cotton fabric with an oxidizing system to obtain an oxidized cotton material. US-A-20210269969 discloses a process for separation of the cellulosic part from a raw material composition comprising polyester and cellulose, involving using a hydrolyzing liquor to alkalize the polyester/cellulose blend. WO2021/181007 discloses a method for separation of cellulosic fibres and non-cellulosic fibres from a mixed fibre textile material, comprising mechanical disintegration of the textile material and subsequent acid treatment followed by alkaline treatment. IN-A-202011022177discloses manufacturing of nanofibres from waste plastic bottles.

Literature shows that majority of textile sorting processes until date focus on cotton or polycotton (Palme et al Text. Cloth. Sustain 2017, 3 (4).) and follows recycling by chemical route as i) dissolution and wet spinning (Liu et al., Carbohydrate Polymers 206 (2019) 141-148) ii) extraction of cellulose nanocrystals (Wang et al Carbohydrate polymers 2017, 157, 945-952; Zhong et al Carbohydrate Polymers 240 (2020) 116283) iii) chemical dissolution of polyester and recovery of cellulose (S. Yousef et al. Journal of Cleaner Production 254 (2020) 12007). Therefore, efforts in Sweden by Renewcell for textile recycling of cotton or polycotton to generate new textile fibres has gained significant interest, where chemical processes break down the textiles into monomers or polymers which is spun into fibres (https://www.renewcell.com/en/section/our-technology/). Simultaneously, green fractionation of textile blends to nanoscaled cellulose and polymers is developed by Mathew and coworkers (Ruiz Caldas et al, ACS Sust Chem Eng. 2022, 10:3787), who have recently produced CNCs from undyed and dyed cotton as well as its blends with polyesters and acrylics. It was also noted that nanocellulose with color can be obtained through this process.

A problem with the solutions of the prior art is that complete separation or depolymerisation of components typically is necessary for recycling purposes, which requires affordable, energy-demanding and complex manufacturing processes. There is thus a need for improved, more environmentally friendly and simplified methods for recycling textiles.

Carette et al. (J Polym Environ 2021; 29:662-671) reports using PET from bottles and cellulose from textiles in making composites. The components come from different sources and the PET do not originate from textiles. Wang et al. (J Appl Polym Sci 2013; 128:3555-3563) used waste cotton fabric in combination with thermoplastic PU of non-textile origin. No chemical treatment step is included in the process. WO 2022/112719 A1 uses fibre from textiles in combination with polymer from non-textile sources. In these studies, the fibre sizes remain in the same range (micron scale) as the feed textiles.

The approach of the present disclosure enables the use of the polymer and cellulose fibres from the same fabric. Furthermore, the chemical pretreatment step followed by thermomechanical processes enables the reduction in the fibres (even down to nanoscale) from the typical diameter of cotton fibres (about 100 microns) down to 100 nm.

### SUMMARY

Thus, since prior art methods typically use complete chemical separation or depolymerisation of the components to do recycling, the present inventors have seen a potential in the opportunity to partially fractionate the textiles to suitable hybrids before converting to new products.

It is one object of the present disclosure to mitigate, alleviate or eliminate one or more of the above-identified deficiencies and disadvantages in the prior art and solve at least the above-mentioned problems.

According to a first aspect there is provided a method for melt processing of textile waste material, wherein the textile waste material comprises (1) at least one thermoplastic polymer material, such as polyurethane, polyester, nylon or elastane, and (2) at least one cellulose-containing material, such as cotton textile, cotton blends with synthetic or natural polymers, regenerated cellulose-based textiles, said method being adapted to prepare a composite material, comprising the steps of:
(a) chemical pretreatment of the textile waste material;
(b) thermomechanical processing of the chemically pretreated material of step, comprising melt compounding, optionally comprising addition of recycled PET, plasticizers, such as glycerol, PEG and vegetable oils, and/or toughening polymers, such as natural rubber and polyurethane;
thereby obtaining a composite material comprising well dispersed polymer composites and/or nanocomposites, wherein the at least one thermoplastic polymer material essentially constitutes a matrix phase and the at least one cellulose-containing material essentially constitutes a reinforcement phase of the composite material.

Hereby, a protocol for melt processing of textiles to prepare composites where the thermoplastic polymers act as the matrix and cotton fibres act as the reinforcement phase is developed as a commercially viable processing route for textile recycling. Typically, the thermoplastic polymer material and the cellulose containing material are from the same textile waste material, i.e., from the same textile source, which is advantageous by simplifying the recycling process. Pretreatments using chemical process routes will be used to facilitate the melt compounding process (i.e., the melt processing) and to optimize the production of well dispersed polymer composites and nanocomposites in a one step process without separating them into the components. This can be controlled by keeping the reduction in weight between the feed fabric and the composite to lower than 5 wt %. The melt processing will typically not chemically modify the material, but it will be physically modified into a homogeneous composite or nanocomposite (by decreasing the size of cellulose fibres). Chemical modification can however be done if additional chemicals are added for creating grafts on cellulose or polymer phase. Moreover, the process is green and gives a way for sustainable recycling of textile waste. For example, there is an advantage in that there is no secondary pollution from the recycling process and all fibrous components of the post-consumer textiles are used by being converted into the new product, i.e., the composite material and thereafter the 3D printable filament. This process can also be extended to other cotton blends containing nylon, elastane etc.

According to some embodiments, the chemical pretreatment is chosen from at least one of the following routes:
(i) partial dissolution of the at least one thermoplastic polymer material using 1:1-1:2 TFA (trifluoroacetic acid) and DCM (dichloromethane);
(ii) citric acid hydrolysis of any cellulose occurring in the at least one thermoplastic polymer material and/or the at least one cellulose-containing material; and
(iii) tempo mediated oxidation of any cellulose occurring in the at least one thermoplastic polymer material and/or the at least one cellulose-containing material.

Hereby, alternative routes for chemical pretreatment are presented, allowing only partial fractionation of the textile material, i.e., by decreasing the size and phase of one of the components in the textile while keeping the other component intact. These are three independent process routes, which have different advantages. The “thermoplastic polymer material” may also be referred to as “the thermoplastic polymer PET phase”. Procedure (i) is most advantageous for cotton blends, whereas procedures (ii) and (iii) are advantageous for pure cotton as well as cotton blends. The chemical pretreatment of the present disclosure makes some changes in the surface chemistry, e.g., oxidation, whereas the melt processing in itself will only lead to homogenization of the mix and reduction in the size of the cellulose phase. In the case of procedure (ii) (citric acid route) and (iii) (the tempo route), the melt processing step can lead to nano scaled cellulose in the product. In this context, “nano scaled” would refer to any cellulose (or other material) having a size smaller than 100 nm. Thus, for a particle to be referred to as “nano sized” or “nano scaled”, it must be smaller than 100 nm in at least one dimension.

Route (i) is an organic solvent-based process, whereas route (ii) and (iii) are water-based processes. In route (i), the polymer phase is partially dissolved (by controlling the amount and ratio of the solvents used) and the cellulose phase is unchanged. In routes (ii) and (iii) the cellulose fraction is modified and/or hydrolysed, whereas the polymer phase remains unchanged.

The chemical treatment removes non-crystalline cellulose and/or adds chemical groups to cellulose (sulphate, citrate, carboxyl) and/or makes the cellulose fibre structures less compact (due to oxidation or esterification which reduces interactions). Physically, the changes are related to weakening of cellulose fibre structure, by cutting it across the fibre length or along the fibre length to generate fibres/fibrils that have a shorter diameter (50 μm to 100 nm) than the feed.

Thus, the chemical pretreatment routes (ii) and (iii) (e.g., as shown in Example 8) are successful in functionalising the cellulose in the textiles and textile blends with chemical groups for ionic crosslinking or interaction with water pollutants. The chemical groups on the cellulose phase will facilitate fibrillation to nanoscale during the thermomechanical processing.

According to some embodiments, chemical pretreatment according to route (ii) and/or (iii) is followed by fibrillation using a mechanical process, and beads processing using (j) a thermally induced phase separation method, or (jj) an oven drying method (as exemplified in Example 4), before subsequent thermomechanical processing. The fibrillation step has the effect of converting the cotton to nanoscale cellulose, and the bead preparation is a process to develop pellets for subsequent thermomechanical processing.

According to some embodiments, the textile waste material is melt-processed at a temperature below 250° C. at ambient pressure.

Hereby, thermoplastic polymers suitable for the disclosed process are used.

According to some embodiments, the cellulose-containing material comprises cellulose I and/or cellulose II polymorphic forms.

Hereby, suitable cellulose-containing materials are used.

According to some embodiments, the textile waste material is chosen from textile clothes or shoes to be recycled, polyester blends, cotton blends containing polyester, elastane, cellulose, polyurethane and/or nylon, shredded polycotton, and shredded acrylic cotton.

Hereby, suitable sources of material are used as starting material. Other sources of textile material may also be used, as long as the other requirements presented in this disclosure are met.

According to some embodiments, the method comprises using the composite material obtained in step (b) for processing by injection molding, compression molding or any other melt processing method, thereby obtaining a recycled product.

Hereby, the composite material obtained is processed and used without subsequent preparation for 3D printing.

According to some embodiments, the method further comprises filament processing of the composite material obtained in step (b), comprising filament extrusion to produce 3D printable filaments.

Hereby, the composite material is prepared for subsequent 3D printing.

According to some embodiments, the method comprises using the 3D printable filament obtained for 3D printing, thereby obtaining a 3D printed recycled product.

Hereby, a 3D printed end-product is obtained

According to a second aspect there is provided a composite material, including well dispersed polymer composites and/or nanocomposites, wherein (1) at least one thermoplastic polymer material essentially constitutes a matrix phase and (2) at least one cellulose-containing material essentially constitutes a reinforcement phase of the composite material, wherein the at least one thermoplastic polymer and the at least one cellulose-containing material originates from the same textile waste material.

Hereby, a novel composite material is provided by a novel process, thereby offering advantages in terms of process efficiency, costs, environmental aspects as well as material properties. Also, a composite material having a high content of cellulose is obtained. The cellulose content may be up to 50%, up to 60%, or even up to 75% for microcomposites, and up to 20% for nanocomposites. Also, by using the composite material as a master batch, the composite mix can be diluted with other polymers thereby lowering the amount of cellulose if needed.

The composite material will undergo a physical change because the synthetic fibre parts melt and lose the fibre structure and become the matrix phase. The cellulose fibres decrease in length and diameter during the melt compounding. Typically, no chemical changes are expected to the cotton or synthetic fibres.

According to some embodiments, the at least one thermoplastic polymer material originates from polyurethane, polyester, nylon, cellulose or elastane, and the at least one cellulose-containing material originates from cotton textile, cotton blends with synthetic or natural polymers, or regenerated cellulose-based textiles.

Hereby, suitable materials are provided in order to obtain the composite material.

According to some embodiments, the composite comprises (i) recycled PET, (ii) plasticizers, such as glycerol, PEG and vegetable oils, and/or (iii) toughening polymers, such as natural rubber and polyurethane.

Hereby, by including plasticizers in the melt compounding, homogenization during melt processing is facilitated. Also, the product is made more flexible. Moreover, toughening agents will help to make the compound less brittle and can be used to adjust the toughness of the composite. Thus, by adding recycled PET, the composition of the composite can be adjusted according to the master batch principle discussed above, i.e., by using the composite composition as a master batch and mix it with other polymers to adjust the composition. Recycled PET can be added from other sources and processing routes (see e.g., Ruiz Caldas et al, ACS Sust Chem Eng. 2022, 10:3787).

According to some embodiments, the thermoplastic polymer is capable of being melt-processed at a temperature below 250° C. at ambient pressure.

According to some embodiments, the cellulose-containing material comprises cellulose I and/or cellulose II polymorphic forms.

According to some embodiments, either (1) the thermoplastic polymer material is fractionated and the cellulose-containing polymer is intact, or (2) the thermoplastic polymer is intact and the cellulose-containing material is fractionated, compared to the original textile waste material. Hereby, a partially fractionated composite material is obtained as a result of chemical pretreatment according to the present disclosure, the fractionated component thereby exhibiting decreased size or phase.

According to some embodiments, the composite material comprises nano scaled cellulose, which may be obtained by fractionating the cellulose-containing material in accordance with e.g., route (ii) or (iii) according to the present disclosure. Nano scaled cellulose may be advantageous for subsequent products based on the composite material of the present disclosure.

According to some embodiments, the composite material is in the form of pellets.

Hereby, recycled composite pellets can be provided as a product. Pellets obtained according to this disclosure will typically be in the form of beads having a diameter of 0.5-1 cm, including up to 50 wt % cellulose.

According to a third aspect there is provided a recycled product comprising the composite material of the second aspect, further being melt processed by injection molding, compression molding or any other melt processing method.

Hereby, by using these methods products are made and shape and form of the composite is changed, thereby obtaining a recycled product from the composite material, without any subsequent 3D printing steps. At this stage, no physical or chemical changes are expected.

According to a fourth aspect there is provided a 3D printable filament comprising the composite material according to the second aspect of the invention, further being filament processed by filament extrusion, for subsequent use in 3D printing to obtain a 3D printed recycled product.

Hereby, a 3D printable filament based on the composite material obtained can be provided, which can be defined as a continuous filament with a prescribed diameter (typically 2.85 mm or 1.75 mm) that can be used in a 3D printer for in-fused filament deposition.

According to a fifth aspect there is provided a 3D printed recycled product comprising the 3D printable filament of the fourth aspect, further being 3D printed.

Hereby, a 3D printed recycled product is provided. The 3D printing will have the effect of structuring the product, but physical or chemical changes are not expected. However, the 3D printed product being made of recycled textiles is unique.

According to some embodiments, the 3D printed recycled product is chosen from a shoe, an interior design product, accessories or a water filter.

In the case of a water filter, the surface chemistry of the cellulose has a beneficial impact also making the chemical treatment of textiles highly relevant and unique. Also, any other product types, that can be 3D-printed based on the composite material, are also included in the scope of the present disclosure.

Effects and features of the second through fifth aspects are to a large extent analogous to those described above in connection with the first aspect. Embodiments mentioned in relation to the first aspect are largely compatible with the second through fifth aspects.

The products and materials defined by the second through fifth aspects may for example be obtained by the method of the first aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular composition of the products described or steps of the methods described since such products and methods may vary. It is also to be understood that the terminology used herein is for the purpose of describing the particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings do not exclude other elements or steps.

### Definitions

The term “well dispersed” is to be interpreted as that the compound/composite is homogeneous. It also means that all components of the composites are dispersed and distributed evenly throughout the materials. This property is important for good and reliable performance of the material and does not exhibit sample to sample or batch to batch variations.

The term “matrix” is to be interpreted as the continuous phase, which acts as the binding phase in the composite material whereas the term “reinforcements” are the dispersed phase and brings increase in mechanical properties to the matrix. Thus, “matrix phase” would be the continuous binder phase in a composite wherein the fibres are dispersed, and the “reinforcement phase” is the fibre component in a composite and has usually a higher stiffness than the matrix phase.

The term “PET phase” is to be interpreted as the polyetherephtalate part of the textile.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a scheme of the process according to the present disclosure indicating the process steps as well as the products obtained.

FIG. 2 shows an overview of the thermomechanical process step of the overall process.

FIG. 3 shows a scheme of the citric acid mediated hydrolysis of cotton-based textiles, and of the tempo mediated alternative route of chemical pretreatment.

FIG. 4 shows FTIR data for chemical functional groups of cellulose from route ii.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

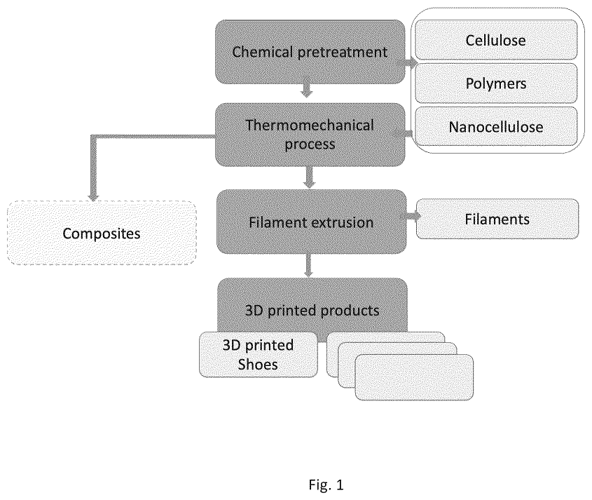

FIG. 1 shows a scheme of the process according to the present disclosure, for melt processing of textile waste material, wherein, as starting material, textile waste material such as textile clothes or shoes to be recycled, polyester blends, cotton blends containing polyester, elastane, cellulose, polyurethane and/or nylon, shredded polycotton, and shredded acrylic cotton are used. The textile waste material comprises at least one thermoplastic polymer material, such as polyurethane, polyester, nylon, cellulose or elastane, and at least one cellulose-containing material, such as cotton textile, cotton blends with synthetic or natural polymers, or regenerated cellulose-based textiles. Typically, the thermoplastic polymer material has the ability to be melt processed at a temperature below 250° C. at ambient pressure, which makes it suitable for the process of this disclosure and the thermomechanical processing step used. The cellulose-containing material is typically of cellulose I and/or cellulose II polymorphic forms, which has proven to be advantageous.

In a first chemical pretreatment step, the textile waste material is only partially dissolved, i.e., complete disintegration is avoided. This can be achieved by any of the disclosed alternative routes:
(i) partial dissolution of the at least one thermoplastic polymer using 1:1-1:2 TFA (trifluoroacetic acid) and DCM (dichloromethane);
(ii) citric acid hydrolysis of cellulose in the at least one thermoplastic polymer material and/or the at least one cellulose-containing material, wherein the concentration of citric acid typically will be within the range of about 80-85 wt %, and the temperature (under normal conditions) typically is in the interval of 90-100° C.; and
(iii) tempo mediated oxidation of cellulose in the polycotton, wherein the ratio between the textile and the reagent is an important parameter. The textile material at 2 wt % concentration in aqueous medium was chemically treated using 0.1 mmol of TEMPO, 0.1 g of NaBr and 10 mmol of NaClO per gram of cellulose at pH 10, maintained using 2 M NaOH solution. After 4 hours, the oxidized material was thoroughly washed until the conductivity was less than 10 μS/cm. The ratio can typically be varied between 5-10 mol NaClO per gram of cotton/cellulose, and the concentration of textile on water can be in the range of 1-3 wt %.

Procedure (i) is most advantageous for cotton blends, whereas procedures (ii) and (iii) are advantageous for pure cotton as well as cotton blends. The chemical pretreatment makes some changes in the surface chemistry, e.g., oxidation, whereas the melt processing in itself will only lead to homogenization of the mix and also reduction in the size of the cellulose phase (as low as 50 nm). For example, oxidation typically changes the hydroxyl groups in cellulose and carbonyl groups or citrate groups. This has been confirmed by chemical analysis (FTIR and NMR). In the case of procedure (iii) (the tempo route), the melt processing step can lead to nanoscaled cellulose in the product.

The chemical pretreatment according to route (ii) or (iii) may be followed by an intermediate step involving fibrillation using a mechanical process, and beads processing using a thermally induced phase separation method. Hereby, intermediate products in the form of cellulose, polymers and/or nanocellulose may be provided.

Alternatively, the chemically treated textiles in water dispersions (2 wt %) were dispersed for 20 minutes using a High-Shear Dispermix (Ystral GmbH, Germany). The obtained dispersion was cast in films with thickness of 1-2 cm which were dried in an oven at 60° C. overnight. The dried films were cut into small square pellets (1 cm×1 cm) using a commercial paper guillotine and followed by thermomechanical processes. This alternative step is performed after the chemical process and is typically needed to melt and compound the two phases into a homogenous master batch or composite.

The chemical pretreatment, optionally followed by fibrillation and/or beads processing, is followed by a thermomechanical processing step, including melt compounding, wherein addition of additional ingredients can be made. These ingredients include, e.g., addition of (i) recycled PET, (ii) plasticisers, such as glycerol, PEG and vegetable oils, and/or (iii) toughening polymers, such as natural rubber and polyurethane, to facilitate the homogeneity of the obtained composite material, and tune the material properties (such as flexibility, brittleness and toughness). These properties can be measured by microscopy data and mechanical property data.

As a result of the chemical pretreatment and the thermomechanical processing, a composite material is obtained, wherein the composite material includes well dispersed (homogenous) polymer composites and/or nanocomposites, wherein the at least one thermoplastic polymer material essentially constitutes a matrix phase and the at least one cellulose-containing material essentially constitutes a reinforcement phase of the composite material.

Ideally, all components of the composites are dispersed and distributed evenly throughout the material, which can be measured using microscopy (optical microscopy, scanning electron microscopy, atomic force microscopy etc.). This property is important for good and reliable performance of the material and does not exhibit sample to sample or batch to batch variations. Further, the chemical pretreatment makes some changes in the surface chemistry; e.g., oxidation, whereas the melt processing in itself will lead to homogenization of the mix and reduction in the size of the cellulose phase. In the case of procedure (ii) (citric acid route) and (iii) (tempo route), the melt processing step can lead to nano-scaled cellulose in the product.

The composite material obtained after the thermomechanical process step may be used directly, preferentially after processing by injection molding, compression molding or any other melt processing method, to obtain a recycled product, such as in the form of a pellets. Thus, the composite can be used to make products with other methods that are widely used in polymer industry. This is in addition to the possibility of 3D printing.

Alternatively, the composite material obtained after thermomechanical processing undergoes filament extrusion to produce 3D printable filaments. The filaments obtained will typically have a diameter of 1.75 or 2.85 mm (+/−0.05 mm) and be produced at a speed of 2 meters per minute.

The 3D printable filaments obtained after filament extrusion may be provided as such (i.e.a, s a sellable end-product), and/or provided for subsequent processing, such as 3D printing.

Alternatively, the 3D printable filaments obtained after filament extrusion are used in a 3D printing process, to obtain a 3D printed recycled products, such as a shoe, clothing, garment, interior design, accessories or water filter. For example, the 3D printing can be performed at a temperature of 220° C. using an Ultimaker S5 (Ultimaker BV, The Netherlands) printer. However, other printers and conditions may also be used.

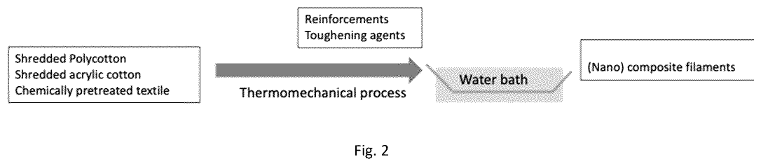

FIG. 2 discloses the thermomechanical process step, being part of the process of this disclosure, wherein a composite fibre is produced in a melt processing device, possibly by adding reinforcements and/or toughening agents, and the resulting extrudate is cooled down in a water bath. The temperature profile during this process is typically 200-225° C.

Now the invention will be further described with reference to examples of embodiments and process steps.

### EXAMPLES

### Example 1—Chemical Pretreatment Route (i)—Partial Dissolution of Thermoplastic Polymer

Cotton/polyester blends with different PET content are used as starting material.

### Partial Dissolution

PET/Cotton (60/40) fabric is cut into 2 cm×2 cm squares. 100 g of the cut fabric were partially dissolved in TFA (trifluoroacetic acid)+DCM (dichloromethane) mix in the proportions 1:2 TFA/DCM. The partially dissolved textile is allowed to dry overnight and is further milled into a finer powder.

### Example 2—Chemical Pretreatment, Procedure (ii): Citric Acid Hydrolysis

Cotton and cotton blends with polyester, acrylics or elastane are used as starting materials.

### Esterification and Partial Hydrolysis of Cotton

Cotton textile fragments were cut into small (<1 cm) pieces and placed into a round-bottom flask containing anhydrous citric acid and water at a concentration of 85 wt %. The ratio of textile to pure citric acid was 1:20 (g/g). The flask was immersed in an oil bath and heated to 100° C. while mixing. The mixture was stirred at 300 rpm using an overhead mechanical stirrer until the citric acid was fully dissolved, and was then, for an additional seven hours before the reaction, quenched by a five-fold dilution with DI water. The quenched mixture was vacuum-filtered onto a Polyethersulfone (PES) membrane (pore size 5 μm) to separate the citric acid solution from the solid fraction that contained carboxylated cotton fibres and residual acid. The citric acid collected from the first filtration was recovered by rotary evaporation and crystallization. DI water was gently added to the filter cake to rinse out the remaining citric acid from the solid. The cake was washed until the conductivity of the filtrate was below 5 μS/cm. Hereby, the washing from the process contains no ions and therefore the product is in a neutral medium.

Textile fragments composed of mixed fabrics (polyester-cotton or acrylic-cotton) were cut into small square pieces with a side length <1 cm. A solution of citric acid 80 wt % was prepared in a rounded flask dissolving 60 g of anhydrous citric acid in 15 ml water and heated to >80° C. using an oil bath. While heating, 195 mg of FeCl₃-equivalent to 0.02 mmol FeCl₃ per gram of citric acid were added to the solution. 2 g of squared pieces were added to the flask and the reaction was performed for six hours mixing with a mechanical stirrer at 400 rpm. After six hours, the reaction was quenched by adding ˜200 ml of deionized water and allowing it to cool at ambient temperature. Longer fibres and a milky suspension were observed. The longer fibres (mainly made of either polyester or acrylic fibres) were separated from the milky suspension using a 250 μm mesh and thoroughly washed with DI water. The suspended particles were precipitated and washed by successive centrifugation cycles until reaching a conductivity below 5 μS/cm.

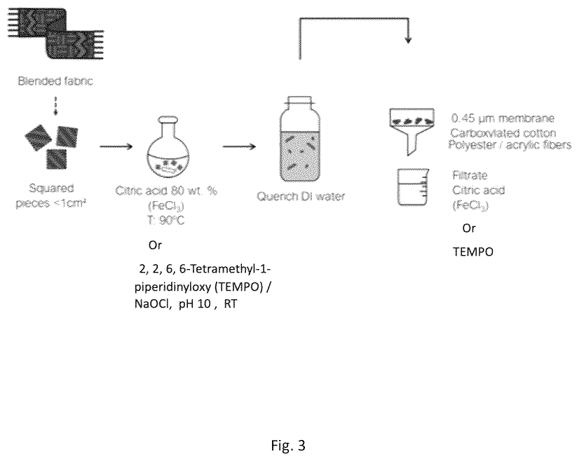

The filter cake of carboxylated cotton fabrics was diluted with DI water to a concentration of approx. 2 wt % and then dispersed in DI water, irrespective of the textile source. FIG. 3 shows a scheme of the citric acid mediated hydrolysis of cotton-based textiles.

### Processing of Nanocellulose

Regardless of the source textile, the obtained dispersion was neutralized by adding drops of NaOH (aq, 1 M) until reaching a pH of 7.0, then diluted to 1.0 wt % and fibrillated using a high-pressure microfluidizer (M-110EH, Microfluidics). Five passes through 400- and 200-μm-wide chambers connected in series were performed at 1000 bar and were followed by five passes through 200- and 100-μm-wide chambers at 1700 bar. After mechanical fibrillation, the resulting dispersion was centrifuged at 10.000g for 10 min and vacuum filtered through a glass microfibre filter (Ahlstrom-Munksjö MGF grade, particle retention 0.7 μm) to remove traces of non-fibrillated cotton. The final product was a colloidal dispersion of CNCs with surface carboxylic groups in sodium form (—COONa).

### Example 3—Chemical Pretreatment, Procedure (iii): Tempo Mediated Oxidation

Textile samples with 100% cotton or cotton blends with polyester, acrylics, wool or elastane are cut into 5 cm square pieces. 2,2,6,6-Tetramethyl-1-piperidinyloxy (TEMPO) mediated oxidation of the textiles were carried out (10 mmol hypochlorite per gram of cotton), cleaned by washing with distilled water (see FIG. 3). The concentration of textile in water is 1.5-2 wt %. NaClO was poured dropwise and simultaneously the pH was adjusted at 10 with 1 M NaOH and 0.5 M HCl (if needed). NOTE: if the targeted charge density is low or medium, the reaction will stop by itself after some minutes or hours (colour change from yellow to white when all chemicals are consumed). If the target charge density is 1.6 mmol COO— /g (high charge), the reaction can be quenched by adding deionized water after minimum 4 hrs. By the end of the reaction, the chemicals are washed out by many cycles of deionized water and filtration, until the conductivity is less than 5-10 μS and the pH is around 8 or at least less than 9.

Finally, the resulting cellulose was filtered and washed several times until the filtrated solution was neutral.

To convert the oxidized cotton into nanocellulose disintegration, ultrafine grinding was used. The suspensions with 1-2 wt % from the chemical treatment process were grinded with a positive gap to avoid grinding of the stones. The material is passed through the grinding stones at least 10 times to achieve nano-scaled material form the cellulose phase.

### Example 4—Processing of Composites and Filaments

The carboxylated products from procedure 2 and procedure 3 (with or without fibrillation) is further used for pellet preparation by following a thermally induced phase separation method or oven drying method, which have been found to be efficient and an alternate process route.

Thermally Induced Phase Separation (TIPS): Master batch of composite spheres was prepared using TIPS technique. This composite dispersion was added to a 20 ml syringe and was manually extruded drop wise into a bath of liquid nitrogen at a distance of 5 cm. To prevent microsphere agglomeration, each droplet was allowed to equilibrate to the liquid nitrogen temperature, demarked by sinking, prior to the addition of further droplets. The droplets solidified upon contact with liquid nitrogen forming spheres and were placed in a freezer overnight, after that freeze-drying was performed for 24 hours.

Oven drying: Alternatively, the chemically treated textiles in water dispersions (2 wt %) were dispersed for 20 minutes using a High-Shear Dispermix (Ystral GmbH, Germany). The obtained dispersion was cast in films with thickness of 1-2 cm which were dried in an oven at 60° C. overnight. The dried films were cut into small square pellets (1 cm×1 cm) using a commercial paper guillotine and followed by thermomechanical processes.

### Example 5—Filament Processing

Twin screw extrusion at 225-250° C. was carried out using fine powder from pellets

### Example 6—3D Printing of Foot Wear

Printer: Ultimaker S5 (Ultimaker BV, The Netherlands).

TABLE 1
Printing parameters for 3D printing of footwear sole and strap

| Layer height: | 0.15 | mm |
|---|---|---|
| Line width: | 0.38 | |
| Wall thickness: | 0.5 | mm |
| Wall line count: | 1 | |
| Outer line: | 0.2 | mm |
| Top/bottom: | 0.5 | mm |
| Top thickness: | 0.5 | mm |
| Bottom thickness: | 0.5 | mm |
| Top/bottom pattern: | Lines | |
| Skin overlap: | 5% | |
| Infill density: | 10% | |
| Infill line distance: | 0.75 | mm |
| Pattern: | Lines | |
| Print temperature: | 220° | C. |
| Print speed: | 20 | mm/s |
| Travel speed: | 150 | mm/s |

Strap and sole were printed separately. Both were printed according to the printing parameters presented in Table 1. The only difference was the print speed of the strap, which was set to 50 mm/s.

Compression test specimens were printed using the filament according to the Standard Test Method for Compressive Properties of Rigid Plastics D695-15 using 25% polycotton/75% TPU. The models were designed and printed out according to the standard, i.e., in the cuboid shape with dimensions of 12.7×12.7×25.4 mm and print infill density of 10%. The specimens were cut out from mesh sole with corresponding, proportional porosity structure. The compressive strength of the non-porous specimen was about 6 MPa and about 2 MPa for porous specimen at 30% compression.

### Example 7—3D Printing of Water Treatment Filters

3D printing: Several different models were 3D printed: (i) cuboid models in standardized size (25.4×12.7×12.7 mm) used for compression testing, (ii) cubic filter models for adsorption study (20×20×20 mm) with varying pore structures i.e., 1 mm, 2 mm and 3 mm. All prototypes were based on cubic and cylindrical computer-aided design (CAD) models. The printing parameters used for both the custom made as well as commercial reference filaments were: nozzle diameter 600 μm, print bed temperature 90° C., printing speed 25 mm/s, layer thickness 150 μm, shell thickness 500 μm, infill density: between 20% and 95% (dependent on the model), infill distance: between 0.1-3 mm (dependent on the model). The printing temperature was set to 250° C. for both filaments used.

Compression testing: Compressive tests were performed according to the Standard Test Method D695-15 on 3D printed cuboid specimens (12.7×12.7×25.4 mm). A 10 kN load cell and a compression rate of 1 mm/min until 60% deformation was reached were applied. The apparent compressive elastic modulus was calculated from the slope of the linear elastic section of the stress-strain curves, without considering the plateau and the densification regime. The energy dissipation, i.e., toughness of the samples, was calculated considering the area under the stress-strain curve. The porous composite filters exhibited a compressive modulus of 350±39 MPa, and a toughness of 10.6±0.5 J/m³.

Dye adsorption: The 3D printed filters were tested for removal of methylene blue (MB) from water. The removal efficiency was assessed with the Ultraviolet—visible (UV-Vis) spectrophotometer (Genesys™, 40/50, ThermoFisher) using the colorimetric method (λ^{max}=664 nm). It was shown that while filters are quite effective for removal of MB from water already after 24 hrs of immersion (approximately 80% removal efficiency at 10 mgl⁻¹), The obtained results indicated that the oxidized nano-fibres are the main adsorptive component of the developed filters as the pure PET filters showed only 10% removal efficiency after 24 hrs of immersion.

### Example 8—Chemical Characteristics of Cellulose Fractions in the Composites

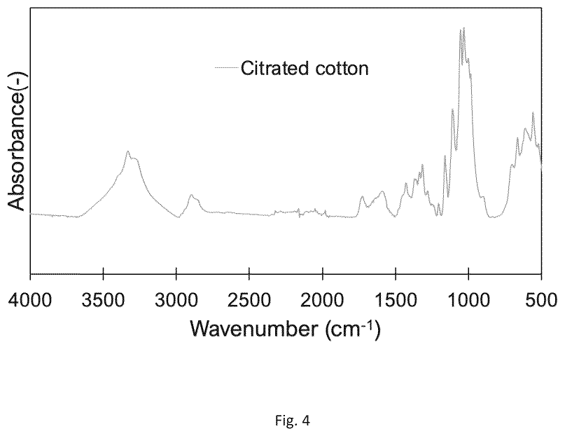

FIG. 4 shows the chemical functional groups of cellulose from route ii. The FTIR of the citrated cotton shows a broad peak in the range 1670-1770 cm⁻¹ corresponding to the C═O stretching vibration band^{58,61} (FIG. 4). In addition, the band centered at 1590 cm⁻¹ corresponds to the asymmetric stretching of —CO₂— group), and those that were part of ester linkages to the cotton (centered at 1725 cm⁻¹ ester C═O vibrations) are visible. These two peaks suggested that the esterification of cellulose was successful and that the carboxyl groups are covalently bonded to cotton. The total carboxylate charge of the citrated cotton was quantified using titration to be 1.1 mmol/g. Around 63% of the carboxylic groups are from monoesters linkages and 37% from diesters.

Chemical funtional groups of cellulose from route iii. The presence of the carboxyl groups was confirmed by FTIR. The FTIR spectra of polycotton included the characteristic peaks of both cotton and PET while the spectrum of the oxidized polycotton and dried polycotton pellets included one extra peak in the range 1602-1633 cm⁻¹ which is assigned to the stretching vibration of the carboxyl sodium salts (COO—) introduced after the TEMPO-mediated oxidation. The charge density of the oxidized polycotton was estimated to be 1.2 mmol COO/g of cellulose indicating that the conditions of the reaction resulted in highly charged cellulose fibres.

Thus, the chemical pretreatment routes (ii) and (iii) are successful in functionalising the cellulose in the textiles and textile blends with chemical groups for ionic crosslinking or interaction with water pollutants. The chemical groups on the cellulose phase will facilitate fibrillation to nanoscale during the thermomechanical processing.

The person skilled in the art realizes that the present disclosure is not limited to the preferred embodiments described above. The person skilled in the art further realizes that modifications and variations are possible within the scope of the appended claims. For example. Additionally, variations to the disclosed embodiments can be understood and effected by the skilled person in practicing the claimed disclosure, from a study of the drawings, the disclosure, and the appended claims.

1. A method for melt processing of textile waste material, wherein the textile waste material comprises (1) at least one thermoplastic polymer material, and (2) at least one cellulose-containing material said method for preparing a nanocomposite material, comprising:
(a) chemical pretreatment of the textile waste material;
(b) thermomechanical processing of the chemically pretreated material of said (a), comprising melt compounding, optionally comprising addition of recycled PET, a plasticizer and/or a toughening polymer; thereby obtaining a nanocomposite material including well dispersed polymer composites and/or nanocomposites, wherein the at least one thermoplastic polymer material essentially constitutes a matrix phase and the at least one cellulose-containing material essentially constitutes a reinforcement phase of the nanocomposite material,
wherein the chemical pretreatment is water-based and is selected from at least one of the following routes:
(i) citric acid hydrolysis of any cellulose occurring in the at least one thermoplastic polymer material and/or the at least one cellulose-containing material, or
(ii) tempo mediated oxidation of any cellulose occurring in the at least one thermoplastic polymer material and/or the at least one cellulose-containing material.

2. The method according to claim 1, wherein the chemical pretreatment according to route (i) and/or (ii) is followed by fibrillation using a mechanical process, whereby intermediate products in a form of nanocellulose is provided, and beads processing using (j) a thermally induced phase separation method, or (jj) an oven drying method, before subsequent thermomechanical processing.

3. The method according to claim 1, wherein the textile waste material is melt processed at a temperature below 250° C. at ambient pressure.

4. The method according to claim 1, wherein the at least one cellulose-containing material comprises cellulose I and/or cellulose II polymorphic forms.

5. The method according to claim 1, wherein the textile waste material is selected from the group consisting of textile clothes or shoes to be recycled, polyester blends, cotton blends containing polyester, elastane, cellulose, polyurethane and/or nylon, shredded polycotton, and shredded acrylic cotton.

6. The method according to claim 1, further comprising using the nanocomposite material obtained in said (b) for processing by injection molding, compression molding or any other melt processing method, thereby obtaining a recycled product.

7. The method according to claim 1, further comprising filament processing of the nanocomposite material obtained in said (b), comprising filament extrusion to produce 3D printable filaments.

8. The method according to claim 1, further comprising using a 3D printable filament obtained for 3D printing, thereby obtaining a 3D printed recycled product.

9. A nanocomposite material originating from textile waste, including well dispersed polymer composites and/or nanocomposites, produced by the method of claim 1, wherein (1) at least one thermoplastic polymer material essentially constitutes a matrix phase and (2) at least one cellulose-containing material essentially constitutes a reinforcement phase of the nanocomposite material, wherein the at least one thermoplastic polymer and the at least one cellulose-containing material originates from the same textile waste material, and wherein the nanocomposite material comprises nano-scaled cellulose.

10. The nanocomposite material according to claim 9, wherein the at least one thermoplastic polymer material originates from polyurethane, polyester, nylon, cellulose or elastane, and the at least one cellulose-containing material originates from cotton textile, cotton blends with synthetic or natural polymers, or regenerated cellulose-based textiles.

11. The nanocomposite material according to claim 9, further comprising (i) recycled PET, (ii) a plasticizer, and/or (iii) a toughening polymer.

12. The nanocomposite material according to claim 9, wherein the at least one cellulose-containing material comprises cellulose I and/or cellulose II polymorphic forms.

13. The nanocomposite material according to claim 9, wherein the at least one thermoplastic polymer is intact and the at least one cellulose-containing material is fractionated, compared to the original textile waste material.

14. The nanocomposite material according to claim 9, wherein the nanocomposite material is in a form of a pellets.

15. A recycled product, comprising the nanocomposite material according to claim 9.

16. A 3D printable filament, comprising the nanocomposite material according to claim 9.

17. A 3D printed recycled product, comprising the 3D printable filament of claim 16.

18. The 3D printed recycled product according to claim 17, selected from the group consisting of a shoe, clothing, a garment, an interior design product, accessories, and a water filter.

19. The method according to claim 1, wherein said at least one thermoplastic polymer material is selected from the group consisting of polyurethane, polyester, nylon, cellulose, and elastane.

20. The method according to claim 1, wherein said at least one cellulose-containing material is selected from the group consisting of cotton textile, cotton blends with synthetic or natural polymers, and regenerated cellulose-based textiles.

21. The method according to claim 1, wherein the plasticizer is selected from the group consisting of glycerol, polyethylene glycol (PEG), and vegetable oil.

22. The method according to claim 1, wherein the toughening polymer is polyurethane.

23. The method according to claim 1, wherein the textile waste material is melt processed at a temperature in an interval of 200-225° C. at ambient pressure.

24. The nanocomposite material according to claim 11, wherein the plasticizer is selected from the group consisting of glycerol, polyethylene glycol(PEG), and vegetable oil.

25. The nanocomposite material according to claim 11, wherein the toughening polymer is polyurethane.
